(19) United States
(12) Patent Application Publication
(10) Pub. No.: US 2025/0071632 A1
(43) Pub. Date: Feb. 27, 2025

(54) PRECONFIGURED MEASUREMENT GAP ENHANCEMENT

(71) Applicant: Apple Inc., Cupertino, CA (US)

(72) Inventors: Yuqin Chen, Beijing (CN); Fangli Xu, Beijing (CN); Haijing Hu, Los Gatos, CA (US); Qiming Li, Beijing (CN); Yang Tang, San Jose, CA (US)

(73) Assignee: Apple Inc., Cupertino, CA (US)

(21) Appl. No.: 18/725,114

(22) PCT Filed: Jan. 6, 2022
(86) PCT No.: PCT/CN2022/070538

§ 371 Date: Jun. 27, 2024

(51) Int. Cl. H04W 36/00

(52) U.S. Cl. CPC H04W 36/0069; H04W 36/0088

(57) ABSTRACT

Provided is a method performed by a user equipment (UE), comprising: receiving, from a network (NW) comprising a master node (MN) and a secondary node (SN), one or more messages comprising pre-configured measurement gap (pre-MG) configurations for at least one pre-MG, wherein the UE is in dual connectivity (DC) with the MN and the SN; and determining, from the pre-MG configurations, respective pre-MG statuses for the at least one pre-MG, wherein the MN comprises a master cell group (MCG) and the SN comprises a secondary cell group (SCG).

### TECHNICAL FIELD

This application relates generally to wireless communication systems, and more specifically to preconfigured measurement gap enhancement.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method performed by a user equipment (UE) is provided. The method comprises: receiving, from a network (NW) comprising a master node (MN) and a secondary node (SN), one or more messages comprising pre-configured measurement gap (pre-MG) configurations for at least one pre-MG, wherein the UE is in dual connectivity (DC) with the MN and the SN; and determining, from the pre-MG configurations, respective pre-MG statuses for the at least one pre-MG.

According to an aspect of the present disclosure, a method performed by a master node (MN) is provided. The method comprises: determining, from pre-configured measurement gap (pre-MG) configurations for at least one pre-MG, first respective pre-MG statuses for the at least one pre-MG, wherein a user equipment (UE) is in dual connectivity (DC) with the MN and a secondary node (SN), wherein the MN comprises a master cell group (MCG) and the SN comprises a secondary cell group (SCG).

According to an aspect of the present disclosure, a method performed by a secondary node (SN) is provided. The method comprises: determining, from pre-configured measurement gap (pre-MG) configurations for at least one pre-MG, first respective pre-MG statuses for the at least one pre-MG, wherein a user equipment (UE) is in dual connectivity (DC) with a master node (MN) and the SN, wherein the MN comprises a master cell group (MCG) and the SN comprises a secondary cell group (SCG).

According to an aspect of the present disclosure, an apparatus for a user equipment (UE) is provided. The apparatus comprises one or more processors configured to perform steps of the method according to any of methods by the UE provided herein.

According to an aspect of the present disclosure, an apparatus for a master node (MN) is provided. The apparatus comprises one or more processors configured to perform steps of the method according to any of methods by the MN provided herein.

According to an aspect of the present disclosure, an apparatus for a secondary node (SN) is provided. The apparatus comprises one or more processors configured to perform steps of the method according to any of methods by the SN provided herein.

According to an aspect of the present disclosure, a computer readable medium is provided, having computer programs stored thereon which, when executed by one or more processors, cause an apparatus to perform steps of the method according to any of methods provided herein.

According to an aspect of the present disclosure, an apparatus for a communication device is provided. The apparatus comprises means for performing steps of the method according to any of methods provided herein.

According to an aspect of the present disclosure, a computer program product is provided, comprising computer programs which, when executed by one or more processors, cause an apparatus to perform steps of the method according to any of methods provided herein.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station (BS) and a user equipment (UE) in accordance with some embodiments.

FIG. 2 depicts an application scenario where a UE is in Dual Connectivity (DC) with a master node (MN) and a secondary node (SN).

FIG. 3A depicts a scenario illustrating a determination on single pre-MG's actual status in carrier aggregation (CA).

FIG. 3B depicts a scenario illustrating a determination on multiple pre-MGs' actual statuses in CA.

FIG. 4 illustrates a method for determination on pre-MGs' actual statuses on UE side in accordance with some embodiments.

FIGS. 5A-5C illustrate different DC scenarios for determination on pre-MGs' actual statuses in accordance with some embodiments.

FIG. 6 illustrates a method for determination on pre-MGs' actual statuses on MN side in accordance with some embodiments.

FIG. 7 illustrates a scenario for determination on pre-MGs' actual statuses for NW in accordance with some embodiments.

FIG. 8 illustrates a transmitting scenario for determination on pre-MGs' actual statuses on NW side in accordance with some embodiments.

FIG. 9 illustrates another transmitting scenario for determination on pre-MGs' actual statuses on NW side in accordance with some embodiments.

FIG. 10 illustrates another transmitting scenario for determination on pre-MGs' actual statuses on NW side in accordance with some embodiments.

FIG. 11 illustrates a method for determination on pre-MGs' actual statuses on SN side in accordance with some embodiments.

FIG. 12 illustrates a block diagram of an apparatus for a UE in accordance with some embodiments.

FIG. 13 illustrates a block diagram of apparatuses for a MN in accordance with some embodiments.

FIG. 14 illustrates a block diagram of apparatuses for a SN in accordance with some embodiments.

FIG. 15 illustrates example components of a device in accordance with some embodiments.

FIG. 16 illustrates example interfaces of baseband circuitry in accordance with some embodiments.

FIG. 17 is a block diagram illustrating components, according to some example embodiments.

FIG. 18 illustrates an architecture of a system of a network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

Wireless communication systems may be capable of supporting communication with multiple users by sharing the available system resources (e.g., time, frequency, and power). A wireless multiple-access communication system may include a number of base stations or network access nodes, each simultaneously supporting communication for multiple UE.

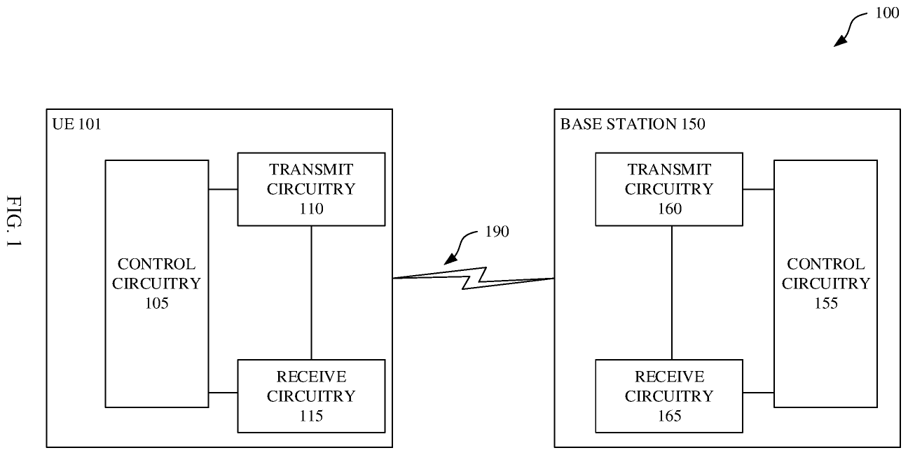

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120 degree area with an array of antennas directed to each sector to provide 360 degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuity 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

In some wireless communication systems, a UE may engage in a dual connectivity (DC) with multiple base stations or nodes. For instance, a first base station may act as a master node (MN) and a second base station may act as a secondary node (SN). The base station acting as the MN and the base station acting as the SN may both have a capability to operate in a first set of frequency band ranges or bands (e.g., legacy LTE or sub 6 gigahertz (GHz) frequency band ranges).

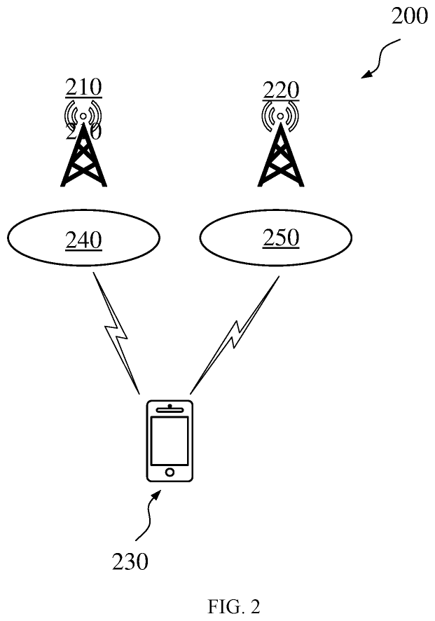

FIG. 2 depicts an application scenario 200 where a UE 230 is in Dual Connectivity (DC) with a master node (MN) and a secondary node (SN) in accordance with some embodiments. As shown in FIG. 2, UE 230 is in dual connectivity with a first base station 210 and a second based station 220. The first base station 210 may act as a MN and the second base station 220 may act as a SN. The MN 210 comprises a master cell group (MCG) 240 and the SN 220 comprises a secondary cell group (SCG) 250.

In some cases, the UE 230 may be in E-UTRA NR DC (EN-DC), NR E-UTRA DC (NE-DC) or NR DC (NR-DC).

Sometimes, the UE may need to handover to another cell. While simultaneously transmitting/receiving on the serving cell, the UE may need measurement gaps to perform measurement on a target carrier frequency. For a legacy measurement gap (MG), there are three different Measurement Gap configurations:

Per FR1 gap: This MG configuration can only be applied to FR1. It cannot be configured together with Per UE gap. E.g., when UE is in EN-DC and FR1 frequency needs to measure, then gNB will configure either Per FR1 gap or Per UE gap.

Per FR2 gap: This MG configuration can only be applied to FR2. Similar to Per FR1 gap, Per FR2 gap cannot be configured together with Per UE gap. E.g., if UE is in EN-DC and FR2 needs to measure, then gNB will configure either Per FR2 gap or Per UE gap. FR1 gap and FR2 gap can be simultaneously configured (activated).

Per UE gap: This MG configuration can be applied to all frequencies, i.e., FR1 and FR2. If Per UE gap is configured, then neither gapFR1 nor gapFR2 can be configured. With this MG configuration, UE can measure FR1, FR2 and non NR RAT.

In the case of dual connectivity, the MG configuration of the MN and the MG configuration of the SN may need to be coordinated. TABLE 1 below illustrates MN/SN coordination and responsible node for measurement gap configuration:

TABLE 1

| Deploy- | Per UE | FR1 | FR2 | |
|---|---|---|---|---|
| ment | gap | gap | gap | Coordination between MN/SN |
| (NG) | MN | MN | SN | Per UE gap: |
| EN-DC | | | | MN->SN: gapPurpose = perUE, |
| | | | | gapPattern |
| | | | | SN->MN: SN configured FR1/FR2 |
| | | | | frequency list to measure |
| | | | | Per FR gap: |
| | | | | MN->SN: gap Purpose = perFR1, gap |
| | | | | pattern, MN configured FR2 frequency |
| | | | | list to measure |
| | | | | SN->MN: SN configured FR1 |
| | | | | frequency list to measure |
| NE-DC | MN | MN | MN | MN->SN: gapPurpose (perUE or |
| | | | | perFR1), gap pattern SN->MN: gap |
| | | | | request to MN |
| NR-DC | MN | MN | MN | MN->SN: gapPurpose (perUE or |
| | | | | perFR1), gap pattern for perUE, |
| | | | | perFR1, perFR2 |
| | | | | SN->MN: SN configured FR1/FR2 |
| | | | | frequency list to measure |

With couple of issues related to the current measurement gap design, several proposals for gap enhancement have been discussed.

In Rel-17, Feature 1: preconfigured MG (Pre-MG) has been provided. The preconfigured MG is per bandwidth part (BWP) activated or deactivated. Pre-MG could be per UE, FR1 or FR2 gap. BWP switching can be done via RRC, DCI, upon timer expiry, or upon RACH initiation. Multiple Radio DC (MR-DC) is deprioritized in Rel-17.

Feature 2: Concurrent gaps has been provided. Multiple gaps are configured/activated, with each gap associated with one MO/RAT/purpose. MR-DC may also be deprioritized in Rel-17. For concurrent gap, the coordination between MN/SN can follow legacy per UE, FR1, FR2 gap.

Feature 3: NCSG gap. This is designed on top of Rel-16 NeedForGap, which does not support MR-DC.

Feature 4: MUSIM gap. UE requests multiple gap pattern(s) to gNB to allow UE to perform operation on the other SIM (SIB, paging reception, RRM, etc.) and gNB configures UE with a per-UE gap (only per UE gap is supported); MR-DC is not supported, and no gap coordination is supported. For MUSIM gap, legacy gap coordination can be used simply.

Feature 5: FR2 UL gap FR2 UL gap has no impact to FR1 operation, and likely is independent from legacy measurement gap. No need to have MN-SN coordination in MR-DC. For FR2 UL gap, it may or may not support MR-DC scenario for the first three features.

For feature 1, the pre-MG design, some basic frameworks have been provided: The preconfigured MG can be either activated or not for each BWP, so that when UE works on certain BWP, UE does not need to apply MG to save the scheduling opportunity.

The preconfigured MG is applicable to all MO(s), meaning that UE activates/deactivates the pre-configured MG only considering the BWP currently operating on.

In some cases, the determination on pre-MG status may be done through NW by indicating the activation/deactivation status to UE per each BWP. Or UE may determine the pre-MG status when the corresponding principle is met, i.e., the active BWP bandwidth covers the whole MO, whether UE supports different SCS between serving cell reception and measurement, etc.

In some cases, a combined scheme between pre-MG and concurrent gap may be provided. It is possible to configure multiple pre-MG(s), with each associated with a different MO/RAT/purpose. For each BWP, there might be multiple pre-MG(s) associated.

In the combined scheme, the determination on pre-MG status may be done through NW by indicating the activation/deactivation status for each pre-MG to UE for each BWP. Or UE may determine each pre-MG's status according to the principle for each BWP.

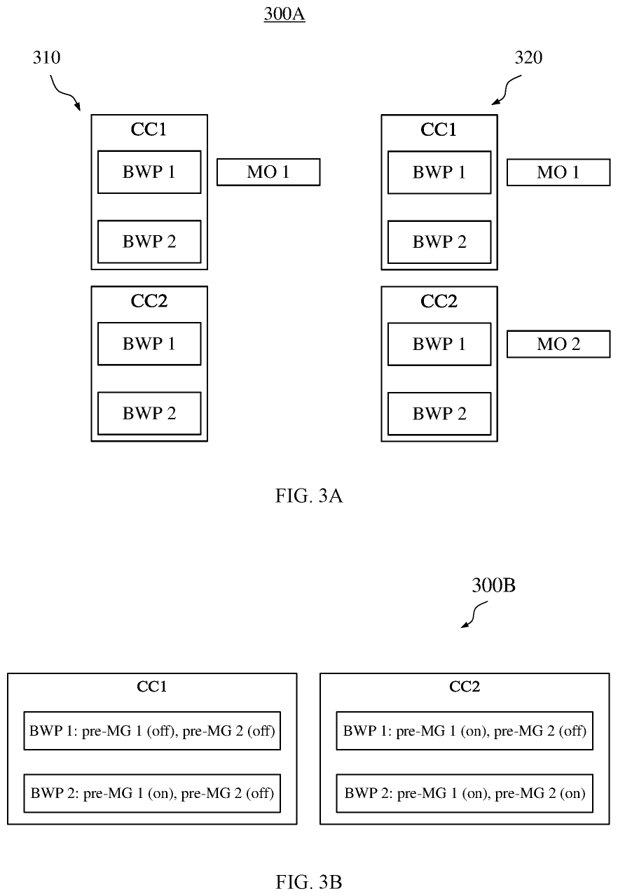

FIG. 3A depicts at 300A scenarios illustrating a determination on single pre-MG's actual status in carrier aggregation (CA). As shown in FIG. 3A, in scenario 310, UE are configured with multiple component carriers (CCs) and each CC is configured with multiple BWPs. For instance, CC1 is configured with BWP 1 and BWP 2, while CC 2 is configured with BWP 1 and BWP 2. In scenario 310, there is only one pre-MG and one measurement occasion (MO), i.e., MO 1. In some cases, UE may determine the actual status of the single pre-MG through explicit indication or implicit indication. In the case of explicit indication, the status of the pre-MG is only considered as “off”, or deactivation in other word, when all active BWPs on all CCs are flagged with “off”. In the case of implicit indication, the status of pre-MG is only considered as “off” when all the reference signal(s) are covered by active BWP(s) on multiple CCs.

In some examples, in scenario 310, NW may configure UE with CC1: {BWP1 off, BWP2 on} and CC2: {BWP1 off, BWP2 off}. NW may also configure UE with absence on pre-MG configuration. For instance, MO 1 is covered by BWP 1 on CC1, and UE may determine the status of pre-MG for BWP 1 on CC1 is off since no measurement gap is needed to perform the measurement. On CC2, off or absent configuration means that there is no measurement task for CC2 RF.

In scenario 320, there are two MOs. NW may configure UE with CC1: {BWP1 off, BWP2 on} and CC2: {BWP1 on, BWP2 off}.

FIG. 3B depicts a scenario 300B illustrating a determination on multiple pre-MGs' actual statuses in CA. Referring to FIG. 3B, there are two pre-MGs, i.e., pre-MG1 and pre-MG2. Note that each pre-MG applies to both CC1 and CC2. In some examples, each pre-MG may be associated with one or multiple MOs as in scenario 310 or 320. In some implementations, for each pre-MG, only when all associated BWPs on all CCs are off, can it be considered as off. The determination of status for each pre-MG may be done through applying both explicit and implicit indications. In the following example, TABLE 2 shows how UE determines statuses for each pre-MG based on NW configuration:

TABLE 2

| | CC2-BWP1 | CC2-BWP2 |
|---|---|---|
| CC1-BWP1 | pre-MG1: on | pre-MG1: on |
| | pre-MG2: off | pre-MG2: on |
| CC1-BWP2 | pre-MG1: on | pre-MG1: on |
| | pre-MG2: off | pre-MG1: on |

Referring to FIG. 3B and TABLE 2, taking pre-MG2 as an example, active BWPs are BWP2 on CC1 and BWP1 on CC2, and pre-MG2 is configured with “off” for BWP2 on CC1 and is also configured with “off” for BWP1 on CC2. In this example, all active BWPs on all CCs are off, and the UE determines the status for the pre-MG2 as off.

In some cases of MR-DC, pre-MG is applied for both MCG and SCG, with the following principle: per UE gap is always applied for UE operation on both MCG and SCG; FR1 gap is normally always applied for FR1 UE operation on both MCG and SCG, since FR1 bands are configured on both MCG and SCG; and for FR2 gap, if FR2-FR2 NR DC is configured, then it is applied for FR2 UE operation on both MCG and SCG, otherwise it is only applied on the CG with FR2 band configured.

In some cases of MR-DC, how the pre-MG status is determined, from both NW side and UE side, remains unsolved. In other cases, the dynamic activation/deactivation of pre-MG is upon BWP switching which is via DCI or timer, which cannot be coordinated in time between MN and SN.

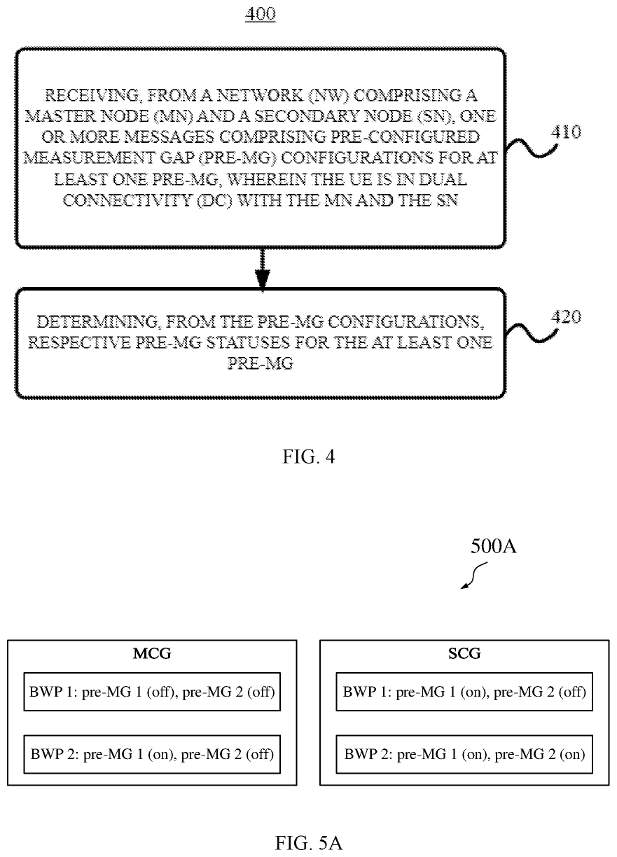

FIG. 4 illustrates a method 400 for determination on pre-MGs' actual statuses on UE side in accordance with some embodiments. As shown in FIG. 4, the method 400 comprises step 410 and step 420.

In step 410, the UE receives, from a network (NW) comprising a master node (MN) and a secondary node (SN), one or more messages comprising pre-configured measurement gap (pre-MG) configurations for at least one pre-MG, wherein the UE is in dual connectivity (DC) with the MN and the SN.

In step 420, the UE determines, from the pre-MG configurations, respective pre-MG statuses for the at least one pre-MG.

In some implementations, the MN comprises a master cell group (MCG) and the SN comprises a secondary cell group (SCG); the pre-MG configurations comprise pre-MG flag indications indicating activation (“on”) or deactivation (“off”) statuses for the at least one pre-MG for at least one bandwidth part (BWP) in at least one of the MCG or the SCG; and the determining respective pre-MG statuses comprises: determining, for each pre-MG, a respective pre-MG status for a first active BWP in the MCG and a second active BWP in the SCG.

In some implementations, pre-MG is only considered off when the active BWPs from both CGs (e.g., MCG and SCG) are flagged as “off”. In some examples, UE may determine a respective pre-MG status for one pre-MG of the at least one pre-MG through explicit indication or implicit indication. In some examples, explicit indication is via flag indication from NW configuration. In some embodiments, when all reference signals are covered by active BWPs, UE may determine that the respective pre-MG statuses on the active BWPs are deactivation statuses.

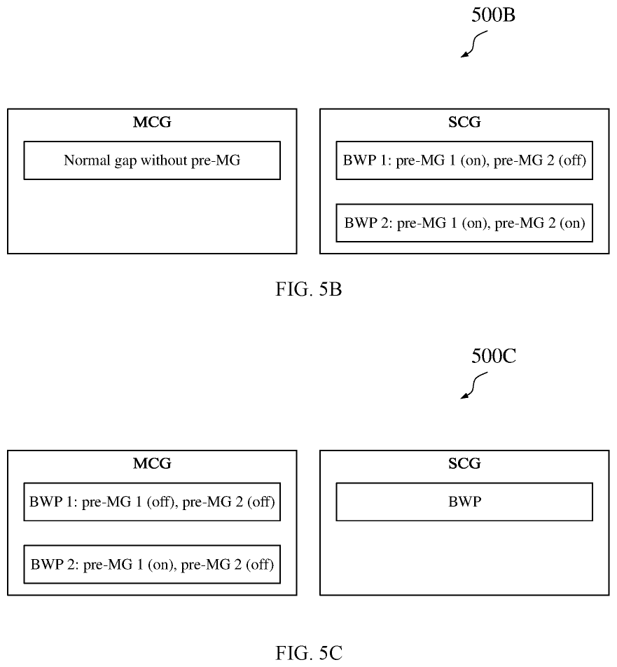

FIGS. 5A-5C illustrate different DC scenarios for determination on pre-MGs' actual statuses in accordance with some embodiments.

Referring to FIG. 5A, scenario 500A is NR-DC. In some embodiments, when the UE is in NR-DC (scenario 500A), the determining, for each pre-MG, the respective pre-MG status comprises: determining, from the pre-MG configurations, a first status of the pre-MG for the first active BWP; determining, from the pre-MG configurations, a second status of the pre-MG for the second active BWP; and in response to a determination that both the first status and the second status are deactivation statuses, determining that the respective pre-MG status for the pre-MG is a deactivation status.

As depicted in FIG. 5A, taking pre-MG2 as an example, when active BWPs are BWP2 on MCG and BWP1 on SCG, pre-MG2 is configured with “off” for both BWP2 on CC1 and BWP1 on CC2. In this example, all active BWPs on all CGs (MCG and SCG) are off, the UE determines that the respective status of the pre-MG2 is off. In some examples, the flag “off” for pre-MG2 may be indicated by the pre-MG configuration from NW. In other examples, the flag “off” for pre-MG2 may be implicitly determined when all reference signals are covered by the active BWPs.

TABLE 3 illustrates respective pre-MG statuses for the two pre-MGs in scenario 500A:

TABLE 3

| Active BWP | | |
|---|---|---|
| in MCG and | | |
| SCG | SCG-BWP1 | SCG-BWP2 |
| MCG-BWP1 | pre-MG1: on | pre-MG1: on |
| | pre-MG2: off | pre-MG2: on |
| MCG-BWP2 | pre-MG1: on | pre-MG1: on |
| | pre-MG2: off | pre-MG1: on |

Referring to FIG. 5B, scenario 500B is EN-DC. In some embodiments, when the UE is in EN-DC (scenario 500B), the determining, for each pre-MG, the respective pre-MG status comprises: determining a third status of the pre-MG for the second active BWP as the respective pre-MG status for the pre-MG. Taking pre-MG1 as an example, a third status of the pre-MG1 for the second active BWP (e.g., BWP1 in SCG) is “on”. In this example, UE determines the respective pre-MG1 status as “on”. In scenario 500B, MN is an E-UTRAN node, meaning that it does not support pre-MG. In some cases, in order to not impact LTE design, pre-MG is limited to FR2 gap. In other examples, when pre-MG is a per UE gap or FR1 gap, MN may need to know the pre-MG configuration in SN in order to avoid erroneous transmission in the measurement gap.

TABLE 4 illustrates respective pre-MG statuses for the two pre-MGs in scenario 500B:

TABLE 4

| Active BWP | | |
|---|---|---|
| in MCG and | | |
| SCG | SCG-BWP1 | SCG-BWP2 |
| MCG | pre-MG1: on | pre-MG1: on |
| | pre-MG2: off | pre-MG2: on |

Referring to FIG. 5C, scenario 500C is NE-DC. In some embodiments, when the UE is in NE-DC (scenario 500C), the determining, for each pre-MG, the respective pre-MG status comprises: determining a fourth status of the pre-MG on the first active BWP as the respective pre-MG status for the pre-MG. Taking pre-MG1 as an example, a fourth status of the pre-MG1 for the first active BWP (e.g., BWP2 in MCG) is “off”. In this example, UE determines the respective pre-MG1 status as “off”. In some examples, all gaps (including the legacy gap and the pre-MG) are configured by MN. In some implementations, the pre-MG can be a per UE, per FR1 or per FR2 gap. In some cases, when a per UE and per FR1 per-MG has a status “on”, SCG operation is impacted and SCG may need to know the pre-MG configuration in MN to avoid erroneous transmission in the measurement gap.

While UE may be able to determine the respective pre-MG status based on various information from MN and/or SN, for NW side, one CG (e.g., MCG) does not have the active BWP information in the other CG (e.g., SCG). In some cases, a way to determine the pre-MG status for NW side may be needed.

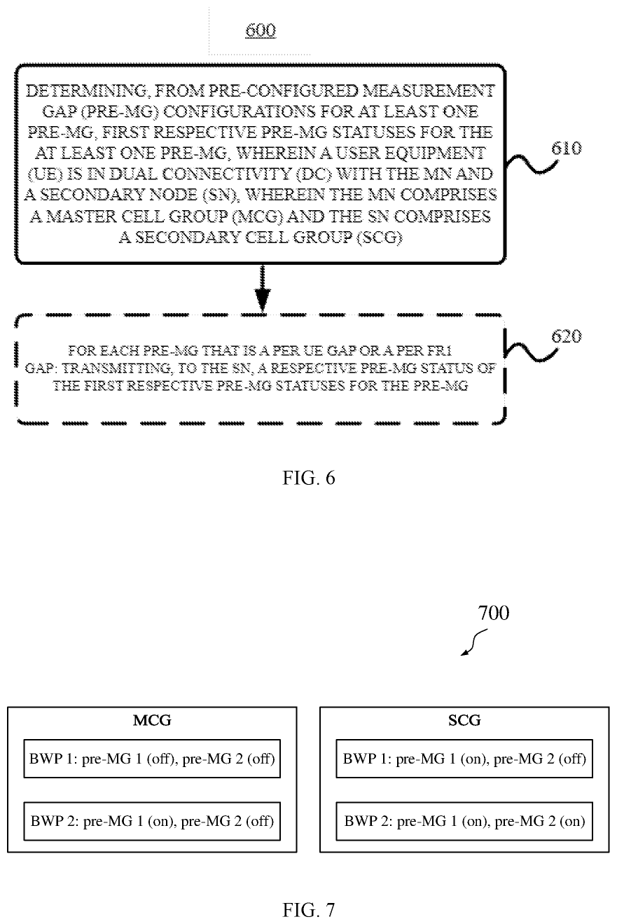

FIG. 6 illustrates methods for determination on pre-MGs' actual statuses on MN and SN side in accordance with some embodiments. As shown in FIG. 6, a method 600 is performed by an MN. The method 600 comprises step 610. In step 610, the MN determines from pre-configured measurement gap (pre-MG) configurations for at least one pre-MG, first respective pre-MG statuses for the at least one pre-MG, where a UE is in dual connectivity (DC) with the MN and a secondary node (SN), wherein the MN comprises a master cell group (MCG) and the SN comprises a secondary cell group (SCG).

In some implementations, the pre-MG configurations comprise first pre-MG flag indications indicating activation or deactivation statuses for each BWP in the MCG and second pre-MG flag indications indicating activation or deactivation statuses for each BWP in the SCG.

In some implementations, a static assumption may be used for the NW. In some examples, the determining the first respective pre-MG statuses comprises: for each pre-MG: determining, from the second pre-MG flag indications, whether at least one of corresponding second pre-MG flag indications for the pre-MG indicates an activation status; in response to a determination that the at least one of corresponding second pre-MG flag indications indicates an activation status, determining that a pre-MG status for the pre-MG is an activation status; and in response to a determination that all the corresponding second pre-MG flag indications indicate deactivation statuses, determining that the pre-MG status for the pre-MG is a status indicated by a corresponding one of the first pre-MG flag indications for an active BWP in the MCG.

In some implementations, for one pre-MG which may be in an activation status (“on”) in the other CG, it is always considered as “on”. Reference is made to FIG. 7, which illustrates a scenario 700 for determination on pre-MGs' actual statuses for NW in accordance with some embodiments. As shown in FIG. 7, for pre-MG1, it could be “on” or “off” in MCG, SCG would consider it is always “on”.

In some implementations, for one pre-MG which is “off” for all BWP(s) in the other CG, it can be considered as “on” or “off” corresponding to the BWP in current CG. For example, as depicted in FIG. 7, for pre-MG2, it is “off” in MCG for two BWP(s), then SCG can consider it as “on” or “off”' based on which BWP is active.

In some implementations, NW may determine pre-MG status by dynamic coordination between MN and SN. In some implementations, when the BWP switching happens in one CG, leading to pre-MG status change, it should be informed to the other node. In some variant, similarly, the bwp-inactivitytimer is informed to the other node, to cover timer-based BWP switching.

In some examples, when the UE is in EN-DC, LTE may not update for pre-MG, thus pre-MG is requested by SN and only applicable for FR2 gap.

In some examples, FR2 pre-MG is only configured in SN, thus no coordination is needed.

TABLE 5 illustrates when the UE is in EN-DC, how NW determines the pre-MG status.

TABLE 5

| Deploy- | Per UE | FR1 pre- | FR2 pre- | Coordination |
|---|---|---|---|---|
| ment | pre-MG | MG | MG | between MN/SN |
| EN-DC | N/A | N/A | SN | No coordination is required |
| | | | | as it is only applied to SN. |

In some embodiments, when UE is in NE-DC, the determining the first respective pre-MG statuses comprises: receiving a configuration or reconfiguration request; and in response to receiving the configuration or reconfiguration request, configuring the first respective pre-MG statuses.

In some embodiments, when the UE is in NE-DC, the determining the first respective pre-MG statuses comprises: in response to a BWP switching on the MN, determining the first respective pre-MG statuses from the pre-MG configurations.

In some embodiments, when the UE is in NE-DC, the method 600 further comprises step 620. In step 620, for each pre-MG that is a per UE gap or a per FR1 gap, MN transmits, to the SN, a respective pre-MG status of the first respective pre-MG statuses for the pre-MG.

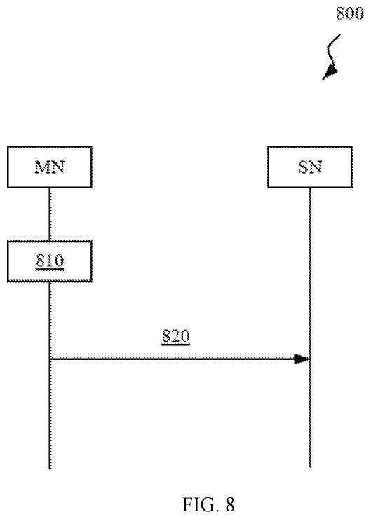

FIG. 8 illustrates a transmitting scenario 800 (NE-DC) for determination on pre-MGs' actual statuses on NW side in accordance with some embodiments. As shown in FIG. 8, the pre-MG status changes when an event 810 occurs. Event 810 may be a configuration or reconfiguration on MN, or a BWP switching on MN.

In some examples, when MN is configured or reconfigured, MN informs SN for each pre-MG, gapPurpose (per UE or per FR1) and pre-MG status indication for each BWP through message 820. In some examples, message 820 may be RRC signaling. In some variant, SN may send a gap request to MN.

In the transmitting scenario 800, pre-MG can be per UE, per FR1 or per FR2 gap. In some examples, for per FR2 pre-MG, there is no need to coordinate between MN and SN as it is confined to MN. In some variants, for per UE and per FR1 pre-MG, MN informs SN about its configuration (e.g., through message 820).

In some implementations, when the event 810 is a BWP switching in MN, MN informs SN (e.g., through message 820) about the per UE pre-MG and per FR1 pre-MG status every time upon a change in the pre-MG status.

TABLE 6 illustrates when UE is in NE-DC, how NW determines the pre-MG status.

TABLE 6

| | Per | | | |
|---|---|---|---|---|
| | UE | FR1 | FR2 | |
| Deploy- | pre- | pre- | pre- | |
| ment | MG | MG | MG | Coordination between MN/SN |
| NE-DC | MN | MN | MN | PerUE, FR1 pre-MG(s) (re)configuration: |
| | | | | MN->SN: For each pre-MG, gapPurpose |
| | | | | (perUE or perFR1), gap pattern, pre-MG |
| | | | | status indication for each BWP |
| | | | | SN->MN: gap request to MN |
| | | | | PerUE, FR1 pre-MG status change upon |
| | | | | BWP switching in MN: |
| | | | | MN->SN: for each perUE and FR1 |
| | | | | pre-MG, Pre-MG status |
| | | | | Note: FR2 pre-MG(s) configuration: No |
| | | | | need to coordinate as it confines to MN |

In some implementations, when the UE is in NR-DC, the determining the first respective pre-MG statuses further comprises: receiving, from the SN, second respective pre-MG statuses for the at least one pre-MG as the first respective pre-MG statuses.

In some implementations, when the UE is in NR-DC, the determining the first respective pre-MG statuses comprises: in response to a BWP switching on the MN, determining the first respective pre-MG statuses from the pre-MG configurations. In some examples, the method 600 may further comprise transmitting, to the SN, the first respective pre-MG statuses.

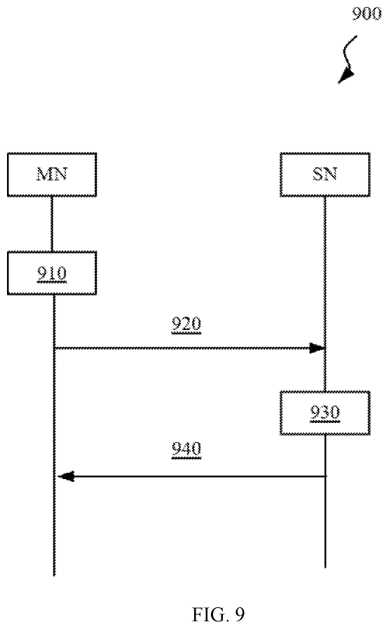

FIG. 9 illustrates another transmitting scenario 900 (NR-DC) for determination on pre-MGs' actual statuses on NW side in accordance with some embodiments.

As shown in FIG. 9, the pre-MG status changes when an event 910 occurs. Event 910 may be a configuration or reconfiguration on MN, or a BWP switching on MN.

In some examples, when MN is configured or reconfigured, MN informs SN for each pre-MG, gapPurpose (per UE or per FR1) and pre-MG status indication for each BWP through message 920. In some examples, message 920 may be RRC signaling. In some variant, SN may send gap request to MN. In some variant, SN may configure an FR1/FR2 frequency list to measure.

In some cases, SN can further configure (930) pre-MG's status to UE for each BWP. In some examples, SN informs MN of each pre-MG's status for each BWP through message 940. In some cases, only MN can configure pre-MG, and the pre-MG can be a per UE, per FR1 or per FR2 gap.

In some embodiments, when the UE is in NR-DC, the determining the first respective pre-MG statuses comprises: in response to a BWP switching on the SN, receiving, from the SN, third respective pre-MG statuses for the at least one pre-MG as the first respective pre-MG statuses.

TABLE 7 illustrates when UE is in NR-DC, how NW determines the pre-MG status.

TABLE 7

| | Per | | | |
|---|---|---|---|---|
| | UE | FR1 | FR2 | |
| Deploy- | pre- | pre- | pre- | |
| ment | MG | MG | MG | Coordination between MN/SN |
| NR-DC | MN | MN | MN | PerUE, FR1, FR2 pre-MG (re)configu- |
| | | | | ration by MN: |
| | | | | SN->MN: SN configured FR1/FR2 |
| | | | | frequency list to measure, |
| | | | | MN->SN: gapPurpose (perUE or perFR1), |
| | | | | gap pattern for perUE, perFR1, perFR2, |
| | | | | pre-MG status indication for each BWP |
| | | | | SN->MN: pre-MG status indication for |
| | | | | each BWP |
| | | | | PerUE, FR1, FR2 pre-MG status change |
| | | | | upon BWP switching in MN/SN: |
| | | | | MN->SN: Pre-MG status |
| | | | | SN->MN: Pre-MG status |

In some implementations, when UE is in NR-DC, the determining the respective pre-MG statuses comprises: in response to a BWP switching on the SN, determining the respective pre-MG statuses from the pre-MG configurations. In some examples, when a BWP switching is on the SN, SN may transmit, to the MN, the respective pre-MG statuses.

In some embodiments, UE may inform the pre-M status change to MCG or SCG, due to BWP switching. In some cases, when UE switches BWP on MN, UE may transmit, to the SN, first reported pre-MG configurations comprising the respective pre-MG statuses. In some implementations, UE may transmit the first reporting pre-MG configurations through RRC signaling, MAC CE or Physical layer signaling. In some examples, the first reporting pre-MG configurations may further comprise a list of identifications (IDs) of the pre-MGs.

In other cases, when UE switches BWP on SN, UE may transmit, to the MN, second reporting pre-MG configurations comprising the respective pre-MG statuses. In some implementations, UE may transmit the second reporting pre-MG configurations through RRC signaling, MAC CE or Physical layer signaling. In some examples, the second reported pre-MG configurations may further comprise a list of identifications (IDs) of the pre-MGs

In some implementations, the determining the first respective pre-MG statuses comprises: transmitting, to the UE, one or more pre-MGs of the at least one pre-MG, that are applicable to both the MCG and the SCG; in response to a BWP switching on the SN, receiving, from the UE, reported pre-MG configurations comprising a set of pre-MG statuses for the one or more pre-MGs. In some implementations, the set of pre-MG statuses is determined by the UE. In some examples, UE may determine the set of pre-MG statuses by method 400 or any embodiments discussed thereof. For MN, corresponding ones of the first respective pre-MG statuses for the one or more pre-MGs are the same as the set of pre-MG statuses. In some cases, MN receives the set of pre-MG statuses determined by the UE as the corresponding ones of the first respective pre-MG.

In some implementations, the reported pre-MG configurations further comprise a list of identifications (IDs) of the one or more pre-MGs.

In some examples, the reported pre-MG configurations are received through RRC signaling, MAC CE or physical layer signaling.

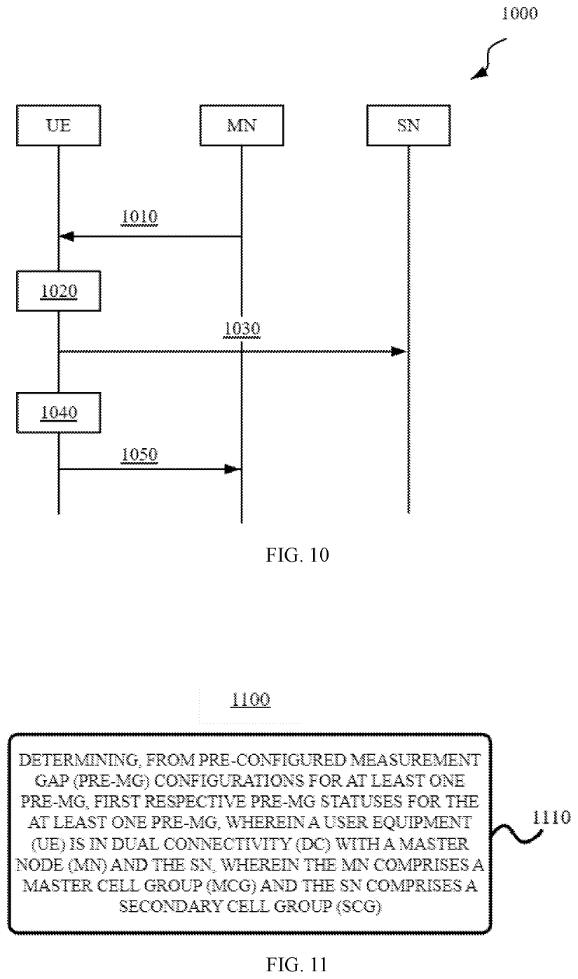

FIG. 10 illustrates another transmitting scenario 1000 for determination on pre-MGs' actual statuses on NW side in accordance with some embodiments. As shown in FIG. 10, MN transmits (1010) one or more pre-MGs to the UE, and the one or more pre-MGs applicable to both MCG and SCG. When a BWP switches (1020) on MN, one or more pre-MGs statuses change, UE reports (1030) the one or more pre-MG statuses via one or more messages.

In some embodiments, when a BWP switches on SN (1040) and one or more pre-MGs statuses change, UE reports the one or more pre-MG statues via one or more messages (1050).

In some examples, UE may report via RRC message/signaling, MAC CE or physical layer signaling. In some examples, the RRC message/signaling may be a UAI message.

In some implementations, NW determines pre-MG status based on NW implementation. For the ideal backhaul case, all information can be exchanged between MN and SN, without further specified solution. In some examples, the determining the first respective pre-MG statuses comprises determining the first respective pre-MG statuses from a network implementation for the MN.

FIG. 11 illustrates a method 1100 for determination on pre-MGs' actual statuses on SN side in accordance with some embodiments. As shown in FIG. 11, method 1100 comprises step 1110. In step 1110, the SN determines, from pre-configured measurement gap (pre-MG) configurations for at least one pre-MG, first respective pre-MG statuses for the at least one pre-MG, wherein a user equipment (UE) is in dual connectivity (DC) with a master node (MN) and the SN, wherein the MN comprises a master cell group (MCG) and the SN comprises a secondary cell group (SCG).

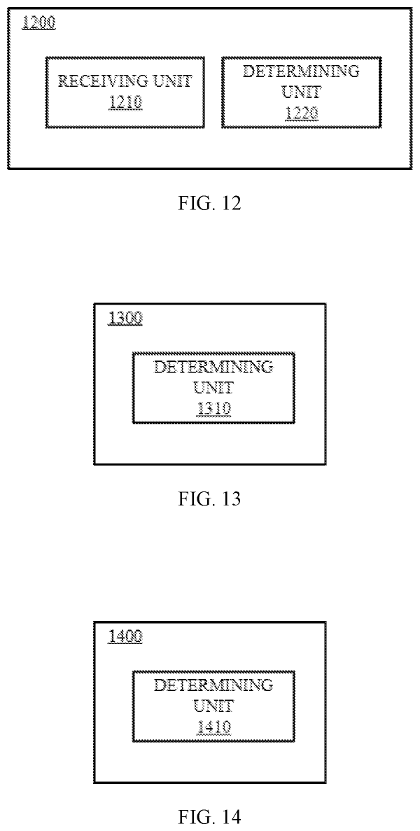

FIG. 12 illustrates a block diagram of an apparatus 1200 for a UE in accordance with some embodiments. The apparatus 1200 illustrated in FIG. 12 may comprise one or more processors configured to perform steps of the method 400 as illustrated in combination with FIG. 12. As shown in FIG. 12, the apparatus 1200 includes receiving unit 1210 and determining unit 1220.

The receiving unit 1210 is configured to receive, from a network (NW) comprising a master node (MN) and a secondary node (SN), one or more messages comprising pre-configured measurement gap (pre-MG) configurations for at least one pre-MG, wherein the UE is in dual connectivity (DC) with the MN and the SN.

The determining unit 1220 is configured to determine, from the pre-MG configurations, respective pre-MG statuses for the at least one pre-MG.

FIG. 13 illustrates a block diagram of apparatus 1300 for an MN in accordance with some embodiments. The apparatus 1300 illustrated in FIG. 13 may comprise one or more processors configured to perform steps of the method 600 as illustrated in combination with FIG. 13. As shown in FIG. 13, the apparatus 1300 includes determining unit 1310.

The determining unit 1310 is configured to determine, from pre-configured measurement gap (pre-MG) configurations for at least one pre-MG, first respective pre-MG statuses for the at least one pre-MG, wherein a user equipment (UE) is in dual connectivity (DC) with the MN and a secondary node (SN), wherein the MN comprises a master cell group (MCG) and the SN comprises a secondary cell group (SCG).

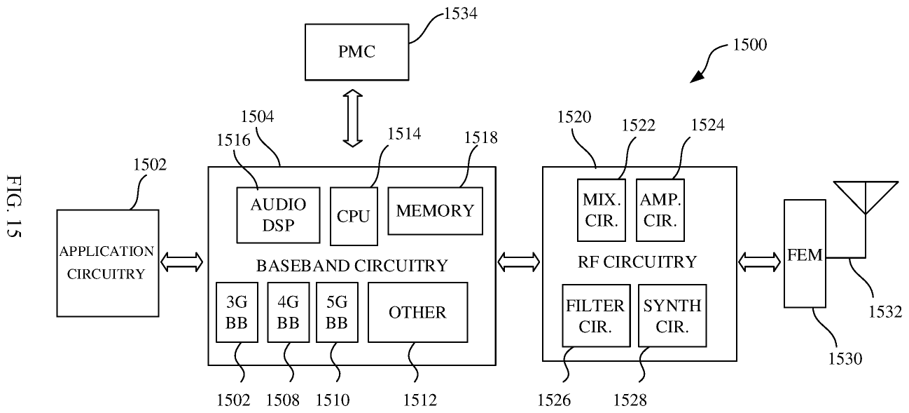

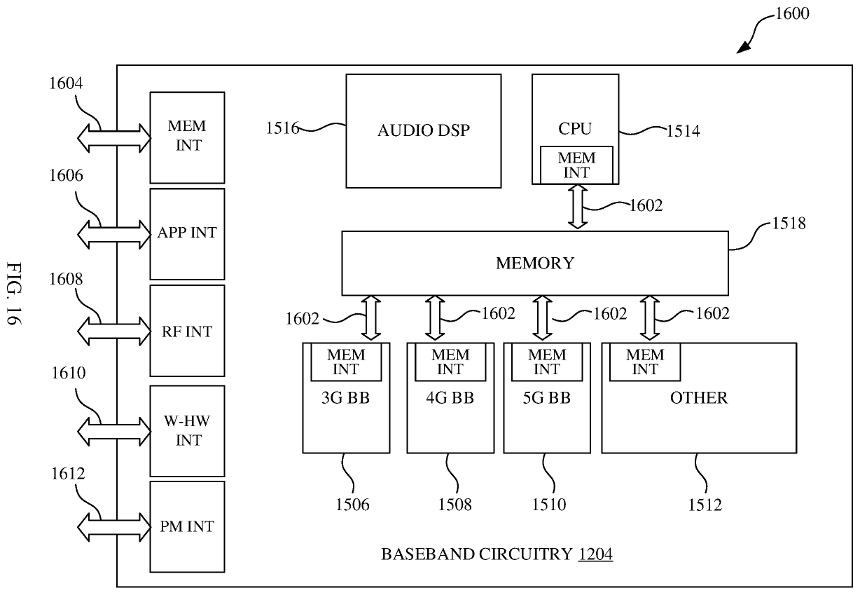

FIG. 14 illustrates a block diagram of apparatus 1400 for an SN in accordance with some embodiments. The apparatus 1400 illustrated in FIG. 14 may comprise one or more processors configured to perform steps of the method 1100 as illustrated in combination with FIG. 14. As shown in FIG. 14, the apparatus 1400 includes determining unit 1410.

The determining unit 1410 is configured to determine, from pre-configured measurement gap (pre-MG) configurations for at least one pre-MG, first respective pre-MG statuses for the at least one pre-MG, wherein a user equipment (UE) is in dual connectivity (DC) with a master node (MN) and the SN, wherein the MN comprises a master cell group (MCG) and the SN comprises a secondary cell group (SCG).

With the embodiments for determination of pre-MG status on UE side, MN side and SN side as discussed, NW can have the same understanding on the pre-MG status as UE. In some cases, when pre-MG is actually “off”' at UE side, scheduling opportunities from NW can get increased. In other cases, when pre-MG is actually “on” at UE side, NW stops scheduling in the gap duration.

FIG. 15 illustrates example components of a device 1500 in accordance with some embodiments. In some embodiments, the device 1500 may include application circuitry 1502, baseband circuitry 1504, Radio Frequency (RF) circuitry (shown as RF circuitry 1520), front-end module (FEM) circuitry (shown as FEM circuitry 1530), one or more antennas 1532, and power management circuitry (PMC) (shown as PMC 1534) coupled together at least as shown. The components of the illustrated device 1500 may be included in a UE or a RAN node. In some embodiments, the device 1500 may include fewer elements (e.g., a RAN node may not utilize application circuitry 1502, and instead include a processor/controller to process IP data received from an EPC). In some embodiments, the device 1500 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1502 may include one or more application processors. For example, the application circuitry 1502 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1500. In some embodiments, processors of application circuitry 1502 may process IP data packets received from an EPC.

The baseband circuitry 1504 may include circuitry such as, but not limited to, one or more single-core or multi-core processors. The baseband circuitry 1504 may include one or more baseband processors or control logic to process baseband signals received from a receive signal path of the RF circuitry 1520 and to generate baseband signals for a transmit signal path of the RF circuitry 1520. The baseband circuitry 1504 may interface with the application circuitry 1502 for generation and processing of the baseband signals and for controlling operations of the RF circuitry 1520. For example, in some embodiments, the baseband circuitry 1504 may include a third generation (3G) baseband processor (3G baseband processor 1506), a fourth generation (4G) baseband processor (4G baseband processor 1508), a fifth generation (5G) baseband processor (5G baseband processor 1510), or other baseband processor(s) 1512 for other existing generations, generations in development or to be developed in the future (e.g., second generation (2G), sixth generation (6G), etc.). The baseband circuitry 1504 (e.g., one or more of baseband processors) may handle various radio control functions that enable communication with one or more radio networks via the RF circuitry 1520. In other embodiments, some or all of the functionality of the illustrated baseband processors may be included in modules stored in the memory 1518 and executed via a Central Processing ETnit (CPET 1514). The radio control functions may include, but are not limited to, signal modulation/demodulation, encoding/decoding, radio frequency shifting, etc. In some embodiments, modulation/demodulation circuitry of the baseband circuitry 1504 may include Fast-Fourier Transform (FFT), precoding, or constellation mapping/demapping functionality. In some embodiments, encoding/decoding circuitry of the baseband circuitry 1504 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1504 may include a digital signal processor (DSP), such as one or more audio DSP(s) 1516. The one or more audio DSP(s) 1516 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1504 and the application circuitry 1502 may be implemented together such as, for example, on a system on a chip (SOC).

In some embodiments, the baseband circuitry 1504 may provide for communication compatible with one or more radio technologies. For example, in some embodiments, the baseband circuitry 1504 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1504 is configured to support radio communications of more than one wireless protocol may be referred to as multi-mode baseband circuitry.

The RF circuitry 1520 may enable communication with wireless networks using modulated electromagnetic radiation through a non-solid medium. In various embodiments, the RF circuitry 1520 may include switches, filters, amplifiers, etc. to facilitate the communication with the wireless network. The RF circuitry 1520 may include a receive signal path which may include circuitry to down-convert RF signals received from the FEM circuitry 1530 and provide baseband signals to the baseband circuitry 1504. The RF circuitry 1520 may also include a transmit signal path which may include circuitry to up-convert baseband signals provided by the baseband circuitry 1504 and provide RF output signals to the FEM circuitry 1530 for transmission. In some embodiments, the receive signal path of the RF circuitry 1520 may include mixer circuitry 1522, amplifier circuitry 1524 and filter circuitry 1526. In some embodiments, the transmit signal path of the RF circuitry 1520 may include filter circuitry 1526 and mixer circuitry 1522. The RF circuitry 1520 may also include synthesizer circuitry 1528 for synthesizing a frequency for use by the mixer circuitry 1522 of the receive signal path and the transmit signal path. In some embodiments, the mixer circuitry 1522 of the receive signal path may be configured to down-convert RF signals received from the FEM circuitry 1530 based on the synthesized frequency provided by synthesizer circuitry 1528. The amplifier circuitry 1524 may be configured to amplify the down-converted signals and the filter circuitry 1526 may be a low-pass filter (LPF) or band-pass filter (BPF) configured to remove unwanted signals from the down-converted signals to generate output baseband signals. Output baseband signals may be provided to the baseband circuitry 1504 for further processing. In some embodiments, the output baseband signals may be zero-frequency baseband signals, although this is not a requirement. In some embodiments, the mixer circuitry 1522 of the receive signal path may comprise passive mixers, although the scope of the embodiments is not limited in this respect.

In some embodiments, the mixer circuitry 1522 of the transmit signal path may be configured to up-convert input baseband signals based on the synthesized frequency provided by the synthesizer circuitry 1528 to generate RF output signals for the FEM circuitry 1530. The baseband signals may be provided by the baseband circuitry 1504 and may be filtered by the filter circuitry 1526.

In some embodiments, the mixer circuitry 1522 of the receive signal path and the mixer circuitry 1522 of the transmit signal path may include two or more mixers and may be arranged for quadrature downconversion and upconversion, respectively. In some embodiments, the mixer circuitry 1522 of the receive signal path and the mixer circuitry 1522 of the transmit signal path may include two or more mixers and may be arranged for image rejection (e.g., Hartley image rejection). In some embodiments, the mixer circuitry 1522 of the receive signal path and the mixer circuitry 1522 may be arranged for direct downconversion and direct upconversion, respectively. In some embodiments, the mixer circuitry 1522 of the receive signal path and the mixer circuitry 1522 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1520 may include analog-to-digital converter (ADC) and digital-to-analog converter (DAC) circuitry and the baseband circuitry 1504 may include a digital baseband interface to communicate with the RF circuitry 1520.

In some dual-mode embodiments, a separate radio IC circuitry may be provided for processing signals for each spectrum, although the scope of the embodiments is not limited in this respect.

In some embodiments, the synthesizer circuitry 1528 may be a fractional-N synthesizer or a fractional N/N+1 synthesizer, although the scope of the embodiments is not limited in this respect as other types of frequency synthesizers may be suitable. For example, synthesizer circuitry 1528 may be a delta-sigma synthesizer, a frequency multiplier, or a synthesizer comprising a phase-locked loop with a frequency divider.

The synthesizer circuitry 1528 may be configured to synthesize an output frequency for use by the mixer circuitry 1522 of the RF circuitry 1520 based on a frequency input and a divider control input. In some embodiments, the synthesizer circuitry 1528 may be a fractional N/N+1 synthesizer.

In some embodiments, frequency input may be provided by a voltage controlled oscillator (VCO), although that is not a requirement. Divider control input may be provided by either the baseband circuitry 1504 or the application circuitry 1502 (such as an applications processor) depending on the desired output frequency. In some embodiments, a divider control input (e.g., N) may be determined from a look-up table based on a channel indicated by the application circuitry 1502.

Synthesizer circuitry 1528 of the RF circuitry 1520 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1528 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1520 may include an IQ/polar converter.

The FEM circuitry 1530 may include a receive signal path which may include circuitry configured to operate on RF signals received from one or more antennas 1532, amplify the received signals and provide the amplified versions of the received signals to the RF circuitry 1520 for further processing. The FEM circuitry 1530 may also include a transmit signal path which may include circuitry configured to amplify signals for transmission provided by the RF circuitry 1520 for transmission by one or more of the one or more antennas 1532. In various embodiments, the amplification through the transmit or receive signal paths may be done solely in the RF circuitry 1520, solely in the FEM circuitry 1530, or in both the RF circuitry 1520 and the FEM circuitry 1530.

In some embodiments, the FEM circuitry 1530 may include a TX/RX switch to switch between transmit mode and receive mode operation. The FEM circuitry 1530 may include a receive signal path and a transmit signal path. The receive signal path of the FEM circuitry 1530 may include an LNA to amplify received RF signals and provide the amplified received RF signals as an output (e.g., to the RF circuitry 1520). The transmit signal path of the FEM circuitry 1530 may include a power amplifier (PA) to amplify input RF signals (e.g., provided by the RF circuitry 1520), and one or more filters to generate RF signals for subsequent transmission (e.g., by one or more of the one or more antennas 1532).

In some embodiments, the PMC 1534 may manage power provided to the baseband circuitry 1504. In particular, the PMC 1534 may control power-source selection, voltage scaling, battery charging, or DC-to-DC conversion. The PMC 1534 may often be included when the device 1500 is capable of being powered by a battery, for example, when the device 1500 is included in a EGE. The PMC 1534 may increase the power conversion efficiency while providing desirable implementation size and heat dissipation characteristics.

FIG. 15 shows the PMC 1534 coupled only with the baseband circuitry 1504. However, in other embodiments, the PMC 1534 may be additionally or alternatively coupled with, and perform similar power management operations for, other components such as, but not limited to, the application circuitry 1502, the RF circuitry 1520, or the FEM circuitry 1530.

In some embodiments, the PMC 1534 may control, or otherwise be part of, various power saving mechanisms of the device 1500. For example, if the device 1500 is in an RRC Connected state, where it is still connected to the RAN node as it expects to receive traffic shortly, then it may enter a state known as Discontinuous Reception Mode (DRX) after a period of inactivity. During this state, the device 1500 may power down for brief intervals of time and thus save power.

If there is no data traffic activity for an extended period of time, then the device 1500 may transition off to an RRC Idle state, where it disconnects from the network and does not perform operations such as channel quality feedback, handover, etc. The device 1500 goes into a very low power state and it performs paging where again it periodically wakes up to listen to the network and then powers down again. The device 1500 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1502 and processors of the baseband circuitry 1504 may be used to execute elements of one or more instances of a protocol stack. For example, processors of the baseband circuitry 1504, alone or in combination, may be used to execute Layer 3, Layer 2, or Layer 1 functionality, while processors of the application circuitry 1502 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

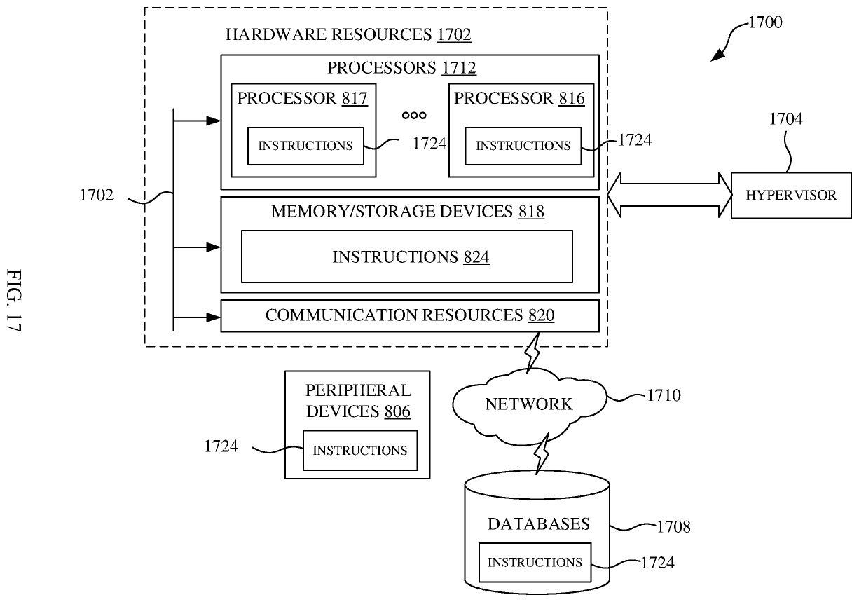

FIG. 16 illustrates example interfaces 1600 of baseband circuitry in accordance with some embodiments. As discussed above, the baseband circuitry 1504 of FIG. 15 may comprise 3G baseband processor 1506, 4G baseband processor 1508, 5G baseband processor 1510, other baseband processor(s) 1512, CPU 1514, and a memory 1618 utilized by said processors. As illustrated, each of the processors may include a respective memory interface 1602 to send/receive data to/from the memory 1618.

The baseband circuitry 1504 may further include one or more interfaces to communicatively couple to other circuitries/devices, such as a memory interface 1604 (e.g., an interface to send/receive data to/from memory external to the baseband circuitry 1604), an application circuitry interface 1606 (e.g., an interface to send/receive data to/from the application circuitry 1502 of FIG. 15), an RF circuitry interface 1608 (e.g., an interface to send/receive data to/from RF circuitry 1520 of FIG. 15), a wireless hardware connectivity interface 1610 (e.g., an interface to send/receive data to/from Near Field Communication (NFC) components, Bluetooth® components (e.g., Bluetooth® Low Energy), Wi-Fi® components, and other communication components), and a power management interface 1612 (e.g., an interface to send/receive power or control signals to/from the PMC 1534.

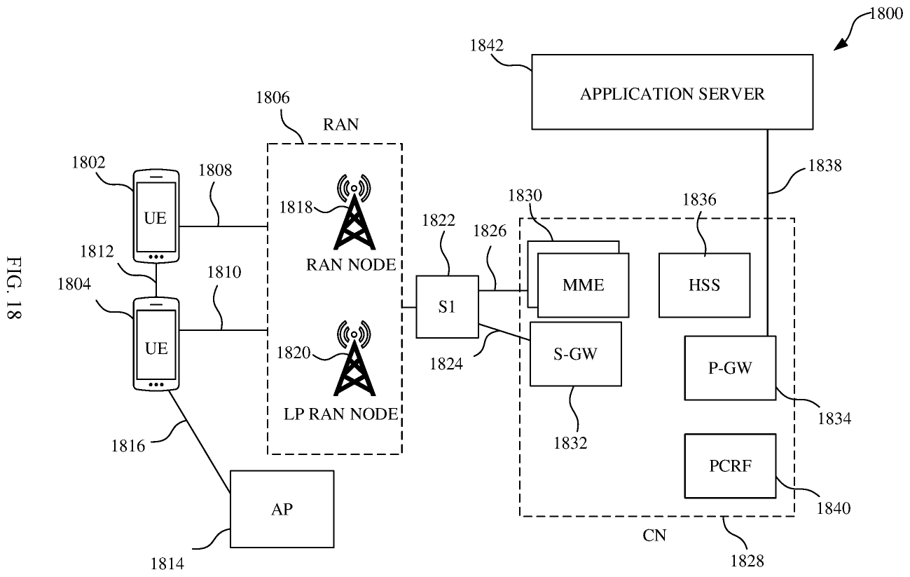

FIG. 17 is a block diagram illustrating components 1700, according to some example embodiments, able to read instructions from a machine-readable or computer-readable medium (e.g., a non-transitory machine-readable storage medium) and perform any one or more of the methodologies discussed herein. Specifically, FIG. 17 shows a diagrammatic representation of hardware resources 1702 including one or more processors 1712 (or processor cores), one or more memory/storage devices 1718, and one or more communication resources 1720, each of which may be communicatively coupled via a bus 1722. For embodiments where node virtualization (e.g., NFV) is utilized, a hypervisor 1704 may be executed to provide an execution environment for one or more network slices/sub-slices to utilize the hardware resources 1702.

The processors 1712 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1714 and a processor 1716.

The memory/storage devices 1718 may include main memory, disk storage, or any suitable combination thereof. The memory/storage devices 1718 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1720 may include interconnection or network interface components or other suitable devices to communicate with one or more peripheral devices 1706 or one or more databases 1708 via a network 1710. For example, the communication resources 1720 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1724 may comprise software, a program, an application, an applet, an app, or other executable code for causing at least any of the processors 1712 to perform any one or more of the methodologies discussed herein. The instructions 1724 may reside, completely or partially, within at least one of the processors 1712 (e.g., within the processor's cache memory), the memory/storage devices 1718, or any suitable combination thereof. Furthermore, any portion of the instructions 1724 may be transferred to the hardware resources 1702 from any combination of the peripheral devices 1706 or the databases 1708. Accordingly, the memory of the processors 1712, the memory/storage devices 1718, the peripheral devices 1706, and the databases 1708 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 18 illustrates an architecture of a system 1800 of a network in accordance with some embodiments. The system 1800 includes one or more user equipment (UE), shown in this example as a UE 1802 and a UE 1804. The UE 1802 and the UE 1804 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1802 and the UE 1104 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. The UE 1802 and the UE 1804 may be configured to connect, e.g., communicatively couple, with a radio access network (RAN), shown as RAN 1806. The RAN 1806 may be, for example, an Evolved ETniversal Mobile Telecommunications System (ETMTS) Terrestrial Radio Access Network (E-UTRAN), a NextGen RAN (NG RAN), or some other type of RAN. The UE 1802 and the UE 1804 utilize connection 1808 and connection 1810, respectively, each of which comprises a physical communications interface or layer (discussed in further detail below); in this example, the connection 1808 and the connection 1810 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1802 and the UE 1804 may further directly exchange communication data via a ProSe interface 1812. The ProSe interface 1812 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1804 is shown to be configured to access an access point (AP), shown as AP 1184, via connection 1816. The connection 1816 can comprise a local wireless connection, such as a connection consistent with any IEEE 802.18 protocol, wherein the AP 1814 would comprise a wireless fidelity (WiFi®) router. In this example, the AP 1814 may be connected to the Internet without connecting to the core network of the wireless system (described in further detail below).

The RAN 1806 can include one or more access nodes that enable the connection 1808 and the connection 1810. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1806 may include one or more RAN nodes for providing macrocells, e.g., macro RAN node 1818, and one or more RAN nodes for providing femtocells or picocells (e.g., cells having smaller coverage areas, smaller user capacity, or higher bandwidth compared to macrocells), e.g., a low power (LP) RAN node such as LP RAN node 1820. Any of the macro RAN node 1818 and the LP RAN node 1820 can terminate the air interface protocol and can be the first point of contact for the UE 1802 and the UE 1804. In some embodiments, any of the macro RAN node 1818 and the LP RAN node 1820 can fulfill various logical functions for the RAN 1806 including, but not limited to, radio network controller (RNC) functions such as radio bearer management, uplink and downlink dynamic radio resource management and data packet scheduling, and mobility management.

In accordance with some embodiments, the EGE 1802 and the EGE 1804 can be configured to communicate using Orthogonal Frequency-Division Multiplexing (OFDM) communication signals with each other or with any of the macro RAN node 1818 and the LP RAN node 1820 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1818 and the LP RAN node 1820 to the UE 1802 and the UE 1804, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1802 and the UE 1804. The physical downlink control channel (PDCCH) may carry information about the transport format and resource allocations related to the PDSCH channel, among other things. It may also inform the UE 1802 and the UE 1804 about the transport format, resource allocation, and H-ARQ (Hybrid Automatic Repeat Request) information related to the uplink shared channel. Typically, downlink scheduling (assigning control and shared channel resource blocks to the UE 1804 within a cell) may be performed at any of the macro RAN node 1818 and the LP RAN node 1820 based on channel quality information fed back from any of the UE 1802 and UE 1804. The downlink resource assignment information may be sent on the PDCCH used for (e.g., assigned to) each of the UE 1802 and the UE 1804.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1806 is communicatively coupled to a core network (CN), shown as CN 1828—via an S1 interface 1822. In embodiments, the CN 1828 may be an evolved packet core (EPC) network, a NextGen Packet Core (NPC) network, or some other type of CN. In this embodiment the S1 interface 1822 is split into two parts: the S1-U interface 1824, which carries traffic data between the macro RAN node 1818 and the LP RAN node 1820 and a serving gateway (S-GW), shown as S-GW 1132, and an S1-mobility management entity (MME) interface, shown as S1-MME interface 1826, which is a signaling interface between the macro RAN node 1818 and LP RAN node 1820 and the MME(s) 1830. In this embodiment, the CN 1828 comprises the MME(s) 1830, the S-GW 1832, a Packet Data Network (PDN) Gateway (P-GW) (shown as P-GW 1834), and a home subscriber server (HSS) (shown as HSS 1836). The MME(s) 1830 may be similar in function to the control plane of legacy Serving General Packet Radio Service (GPRS) Support Nodes (SGSN). The MME(s) 1830 may manage mobility aspects in access such as gateway selection and tracking area list management. The HSS 1836 may comprise a database for network users, including subscription-related information to support the network entities' handling of communication sessions. The CN 1828 may comprise one or several HSS 1836, depending on the number of mobile subscribers, on the capacity of the equipment, on the organization of the network, etc. For example, the HSS 1836 can provide support for routing/roaming, authentication, authorization, naming/addressing resolution, location dependencies, etc.

The S-GW 1832 may terminate the S1 interface 322 towards the RAN 1806, and routes data packets between the RAN 1806 and the CN 1828. In addition, the S-GW 1832 may be a local mobility anchor point for inter-RAN node handovers and also may provide an anchor for inter-3GPP mobility. Other responsibilities may include lawful intercept, charging, and some policy enforcement.

The P-GW 1834 may terminate an SGi interface toward a PDN. The P-GW 1834 may route data packets between the CN 1828 (e.g., an EPC network) and external networks such as a network including the application server 1842 (alternatively referred to as application function (AF)) via an Internet Protocol (IP) interface (shown as IP communications interface 1838). Generally, an application server 1842 may be an element offering applications that use IP bearer resources with the core network (e.g., ETMTS Packet Services (PS) domain, LTE PS data services, etc.). In this embodiment, the P-GW 1834 is shown to be communicatively coupled to an application server 1842 via an IP communications interface 1838. The application server 1842 can also be configured to support one or more communication services (e.g., Voice-over-Internet Protocol (VOIP) sessions, PTT sessions, group communication sessions, social networking services, etc.) for the UE 1802 and the UE 1804 via the CN 1828.

The P-GW 1834 may further be a node for policy enforcement and charging data collection. A Policy and Charging Enforcement Function (PCRF) (shown as PCRF 1840) is the policy and charging control element of the CN 1828. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1840 may be communicatively coupled to the application server 1842 via the P-GW 1834. The application server 1842 may signal the PCRF 1840 to indicate a new service flow and select the appropriate Quality of Service (QOS) and charging parameters. The PCRF 1840 may provision this rule into a Policy and Charging Enforcement Function (PCEF) (not shown) with the appropriate traffic flow template (TFT) and QoS class of identifier (QCI), which commences the QoS and charging as specified by the application server 1842.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method performed by a user equipment (UE), comprising:
receiving, from a network (NW) comprising a master node (MN) and a secondary node (SN), one or more messages comprising pre-configured measurement gap (pre-MG) configurations for at least one pre-MG, wherein the UE is in dual connectivity (DC) with the MN and the SN, wherein the MN comprises a master cell group (MCG) and the SN comprises a secondary cell group (SCG); and
determining, from the pre-MG configurations, respective pre-MG statuses for the at least one pre-MG.

Example 2 is the method of example 1, wherein the pre-MG configurations comprise pre-MG flag indications indicating activation or deactivation statuses for the at least one pre-MG for at least one bandwidth part (BWP) in at least one of the MCG or the SCG, and wherein the determining respective pre-MG statuses comprises:
determining, for each pre-MG, a respective pre-MG status for a first active BWP in the MCG and a second active BWP in the SCG.

Example 3 is the method of example 2, wherein the UE is in NR-DC, and wherein the determining, for each pre-MG, the respective pre-MG status comprises:
determining, from the pre-MG configurations, a first status of the pre-MG for the first active BWP;
determining, from the pre-MG configurations, a second status of the pre-MG for the second active BWP; and
in response to a determination that both the first status and the second status are deactivation statuses, determining that the respective pre-MG status for the pre-MG is a deactivation status.

Example 4 is the method of example 2, wherein the UE is in EN-DC, and wherein the determining, for each pre-MG, the respective pre-MG status comprises:
determining a third status of the pre-MG for the second active BWP as the respective pre-MG status for the pre-MG.

Example 5 is th method of example 4, wherein the pre-MG is a per RF2 gap.

Example 6 is the method of example 2, wherein the UE is in NE-DC, and wherein the determining, for each pre-MG, the respective pre-MG status comprises:
determining a fourth status of the pre-MG on the first active BWP as the respective pre-MG status for the pre-MG.

Example 7 is the method of example 6, wherein the pre-MG is a per UE, per FR1 or per FR2 gap.

Example 8 is the method of example 1, wherein all reference signals are covered by active BWPs, and wherein the determining respective pre-MG statuses comprises:
determining that the respective pre-MG statuses on the active BWPs are deactivation statuses.

Example 9 is the method of example 1, wherein the at least one pre-MG is applicable to both the MCG and the SCG, the method further comprises:
in response to a BWP switching on the MN, transmitting, to the SN, first reporting pre-MG configurations comprising the respective pre-MG statuses.

Example 10 is the method of example 9, wherein the first reporting pre-MG configurations are transmitted through RRC signaling, MAC CE or Physical layer signaling.

Example 11 is the method of example 1, wherein the at least one pre-MG is applicable to both the MCG and the SCG, the method further comprises:
in response to a BWP switching on the SN, transmitting, to the MN, second reporting pre-MG configurations comprising the respective pre-MG statuses.

Example 12 is the method of example 9, wherein the second reporting pre-MG configurations are transmitted through RRC signaling, MAC CE or Physical layer signaling.

Example 13 is a method performed by a master node (MN), comprising:
determining, from pre-configured measurement gap (pre-MG) configurations for at least one pre-MG, first respective pre-MG statuses for the at least one pre-MG, wherein a user equipment (UE) is in dual connectivity (DC) with the MN and a secondary node (SN), wherein the MN comprises a master cell group (MCG) and the SN comprises a secondary cell group (SCG).

Example 14 is the method of example 13, wherein the pre-MG configurations comprise first pre-MG flag indications indicating activation or deactivation statuses for each BWP in the MCG and second pre-MG flag indications indicating activation or deactivation statuses for each BWP in the SCG.

Example 15 is the method of example 14, wherein the determining the first respective pre-MG statuses comprises:
for each pre-MG:
determining, from the second pre-MG flag indications, whether at least one of corresponding second pre-MG flag indications for the pre-MG indicates an activation status;
in response to a determination that the at least one of corresponding second pre-MG flag indications indicates an activation status, determining that a pre-MG status for the pre-MG is an activation status; and
in response to a determination that all the corresponding second pre-MG flag indications indicate deactivation statuses, determining that the pre-MG status for the pre-MG is a status indicated by a corresponding one of the first pre-MG flag indications for an active BWP in the MCG.

Example 16 is the method of example 14, wherein the UE is in NE-DC or NR-DC, wherein the determining the first respective pre-MG statuses comprises:
receiving a configuration or reconfiguration request; and
in response to receiving the configuration or reconfiguration request, configuring the first respective pre-MG statuses.

Example 17 is the method of example 14, wherein the UE is in NE-DC, wherein the determining the first respective pre-MG statuses comprising:
in response to a BWP switching on the MN, determining the first respective pre-MG statuses from the pre-MG configurations.

Example 18 is the method of example 16 or 17, wherein the UE is in NE-DC, the method further comprising:
for each pre-MG that is a per UE gap or a per FR1 gap:
transmitting, to the SN, a respective pre-MG status of the first respective pre-MG statuses for the pre-MG.

Example 19 is the method of example 16, wherein the UE is in NR-DC, wherein the determining the first respective pre-MG statuses further comprises:
receiving, from the SN, second respective pre-MG statuses for the at least one pre-MG as the first respective pre-MG statuses.

Example 20 is the method of example 14, wherein the UE is in NR-DC, wherein the determining the first respective pre-MG statuses comprises:
in response to a BWP switching on the MN, determining the first respective pre-MG statuses from the pre-MG configurations.

Example 21 is the method of example 20, further comprising:
transmitting, to the SN, the first respective pre-MG statuses.

Example 22 is the method of example 14, wherein the UE is in NR-DC, wherein the determining the first respective pre-MG statuses comprising:
in response to a BWP switching on the SN, receiving, from the SN, third respective pre-MG statuses for the at least one pre-MG as the first respective pre-MG statuses.

Example 23 is the method of example 13, wherein the determining the first respective pre-MG statuses comprises:
transmitting, to the UE, one or more pre-MGs of the at least one pre-MG, that are applicable to both the MCG and the SCG;
in response to a BWP switching on the SN, receiving, from the UE, reported pre-MG configurations comprising a set of pre-MG statuses for the one or more pre-MGs, wherein the set of pre-MG statuses is determined by the UE, and wherein corresponding ones of the first respective pre-MG statuses for the one or more pre-MGs are the same as the set of pre-MG statuses.

Example 24 is the method of example 23, wherein the reported pre-MG configurations further comprise a list of identifications (IDs) of the one or more pre-MGs.

Example 25 is the method of example 23, wherein the reported pre-MG configurations is received through RRC signaling, MAC CE or Physical layer signaling.

Example 26 is the method of example 13, wherein the determining the first respective pre-MG statuses comprises:
determining the first respective pre-MG statuses from a network implementation for the MN.

Example 27 is a method performed by a secondary node (SN), comprising:
determining, from pre-configured measurement gap (pre-MG) configurations for at least one pre-MG, first respective pre-MG statuses for the at least one pre-MG, wherein a user equipment (UE) is in dual connectivity (DC) with a master node (MN) and the SN, wherein the MN comprises a master cell group (MCG) and the SN comprises a secondary cell group (SCG).

Example 28 is the method of example 27, wherein the pre-MG configurations comprise first pre-MG flag indications indicating activation or deactivation statuses for each BWP in the SCG and second pre-MG flag indications indicating activation or deactivation statuses for each BWP in the MCG.

Example 29 is the method of example 28, wherein the determining the first respective pre-MG statuses comprises:
for each pre-MG:
determining, from the second pre-MG flag indications, whether at least one of corresponding second pre-MG flag indications for the pre-MG indicates an activation status;
in response to a determination that the at least one of corresponding second pre-MG flag indications indicates an activation status, determining that a pre-MG status for the pre-MG is an activation status; and
in response to a determination that all the corresponding second pre-MG flag indications indicate deactivation statuses, determining that the pre-MG status for the pre-MG is a status indicated by a corresponding one of the first pre-MG flag indications for an active BWP in the MCG.

Example 30 is the method of example 28, wherein the UE is in EN-DC, wherein the second pre-MG flag indications comprise corresponding pre-MG flag indications for each pre-MG that is a per FR2 gap, and wherein the determining the first respective pre-MG statuses comprises:
determining that a pre-MG status for the pre-MG is a status indicated by a corresponding pre-MG flag indication for the pre-MG.

Example 31 is the method of example 28, wherein the UE is in NE-DC, and wherein for each pre-MG that is a per UE gap or a per FR1 gap, the determining the first respective pre-MG statuses comprises:
in response to a BWP switching on the MN, or a configuration or reconfiguration on the MN, receiving, from the MN, a corresponding one of second respective pre-MG statuses for the pre-MG as a corresponding first pre-MG status for the pre-MG.

Example 32 is the method of example 28, wherein the UE is in NR-DC, and wherein the determining the first respective pre-MG statuses comprises:
in response to a BWP switching on the MN, or a configuration or reconfiguration on the MN, receiving, from the MN, third respective pre-MG statuses for the at least one pre-MG as the first respective pre-MG statuses.

Example 33 is the method of example 32, further comprising:
in response to the configuration or reconfiguration on the MN, configuring the first respective pre-MG statuses; and
transmitting, to the MN, the configured first respective pre-MG statuses.

Example 34 is the method of example 28, wherein the UE is in NR-DC, and wherein the determining the first respective pre-MG statuses comprises:
in response to a BWP switching on the SN, determining the first respective pre-MG statuses from the pre-MG configurations.

Example 35 is the method of example 34, further comprising:
transmitting, to the MN, the first respective pre-MG statuses.

Example 36 is the method of example 27, wherein the determining the first respective pre-MG statuses comprising:
in response to a BWP switching on the MN, receiving, from the UE, reported pre-MG configurations comprising a set of pre-MG statuses for the one or more pre-MGs, wherein the set of pre-MG statuses is determined by the UE, and wherein corresponding ones of the first respective pre-MG statuses for the one or more pre-MGs are the same as the set of pre-MG statuses.

Example 37 is the method of example 36, wherein the reported pre-MG configurations further comprise a list of identifications (IDs) of the one or more pre-MGs.

Example 38 is the method of example 36, wherein the reported pre-MG configurations is received through RRC signaling, MAC CE or Physical layer signaling.

Example 39 is the method of example 27, wherein the determining the first respective pre-MG statuses comprises:
determining the first respective pre-MG statuses from a network implementation for the SN. Example 40 is an apparatus for a user equipment (UE), the apparatus comprising:
one or more processors configured to perform steps of the method according to any of examples 1-12.

Example 41 is an apparatus for a master node (MN), the apparatus comprising:
one or more processors configured to perform steps of the method according to any of examples 13-26.

Example 42 is an apparatus for a secondary node (SN), the apparatus comprising:
one or more processors configured to perform steps of the method according to any of examples 27-39.

Example 43 is a computer readable medium having computer programs stored thereon which, when executed by one or more processors, cause an apparatus to perform steps of the method according to any of examples 1-39.

Example 44 is an apparatus for a communication device, comprising means for performing steps of the method according to any of examples 1-39.

Example 45 is a computer program product comprising computer programs which, when executed by one or more processors, cause an apparatus to perform steps of the method according to any of examples 1-39.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-45. (canceled)

46. A method performed by a user equipment (UE) or a component of a UE, comprising:
receiving, from a network (NW) comprising a master node (MN) and a secondary node (SN), one or more messages that include at least one pre-configured measurement gap (pre-MG) configuration for at least one pre-MG, wherein the UE is in dual connectivity (DC) with the MN and the SN, wherein the MN is associated with a master cell group (MCG) and the SN is associated with a secondary cell group (SCG); and
determining, from the at least one pre-MG configuration, respective pre-MG statuses for the at least one pre-MG.

47. The method of claim 46, wherein the pre-MG configurations comprise pre-MG flag indications indicating activation or deactivation statuses for the at least one pre-MG for at least one bandwidth part (BWP) in at least one of the MCG or the SCG, and wherein the determining respective pre-MG statuses comprises:
determining, for each pre-MG, a respective pre-MG status for a first active BWP in the MCG and a second active BWP in the SCG.

48. The method of claim 47, wherein the UE is in NR-DC, and wherein the determining, for each pre-MG, the respective pre-MG status comprises:
determining, from the pre-MG configurations, a first status of the pre-MG for the first active BWP;
determining, from the pre-MG configurations, a second status of the pre-MG for the second active BWP; and
in response to a determination that both the first status and the second status are deactivation statuses, determining that the respective pre-MG status for the pre-MG is a deactivation status.

49. The method of claim 47, wherein the UE is in EN-DC, and wherein the determining, for each pre-MG, the respective pre-MG status comprises:
determining a third status of the pre-MG for the second active BWP as the respective pre-MG status for the pre-MG,
wherein the pre-MG is a per RF2 gap.

50. The method of claim 47, wherein the UE is in NE-DC, and wherein the determining, for each pre-MG, the respective pre-MG status comprises:
determining a fourth status of the pre-MG on the first active BWP as the respective pre-MG status for the pre-MG,
wherein the pre-MG is a per UE, per FR1 or per FR2 gap.

51. The method of claim 46, wherein all reference signals are covered by active BWPs, and wherein the determining respective pre-MG statuses comprises:
determining that the respective pre-MG statuses on the active BWPs are deactivation statuses.

52. The method of claim 46, wherein the at least one pre-MG is applicable to both the MCG and the SCG, the method further comprising:
in response to a BWP switching on the MN, transmitting, to the SN, first reporting pre-MG configurations comprising the respective pre-MG statuses,
wherein the first reporting pre-MG configurations are transmitted through radio resource control (RRC) signaling, media access control (MAC) control element (CE) or Physical layer signaling.

53. An apparatus comprising:
processing circuitry to:
determine, from pre-configured measurement gap (pre-MG) configurations for at least one pre-MG, first respective pre-MG statuses for the at least one pre-MG, wherein a user equipment (UE) is in dual connectivity (DC) with a master node (MN) and a secondary node (SN),
wherein the MN is associated with a master cell group (MCG) and the SN is associated with a secondary cell group (SCG); and
an interface to communicatively couple the processing circuitry to a component of a device.

54. The apparatus of claim 53, wherein the pre-MG configurations comprise first pre-MG flag indications indicating activation or deactivation statuses for each BWP in the MCG and second pre-MG flag indications indicating activation or deactivation statuses for each BWP in the SCG.

55. The apparatus of claim 54, wherein to determine the first respective pre-MG statuses comprises:
for each pre-MG:
determine, from the second pre-MG flag indications, whether at least one of corresponding second pre-MG flag indications for the pre-MG indicates an activation status;
in response to a determination that the at least one of corresponding second pre-MG flag indications indicates an activation status, determine that a pre-MG status for the pre-MG is an activation status; and
in response to a determination that all the corresponding second pre-MG flag indications indicate deactivation statuses, determine that the pre-MG status for the pre-MG is a status indicated by a corresponding one of the first pre-MG flag indications for an active BWP in the MCG.

56. The apparatus of claim 54, wherein the UE is in NE-DC or NR-DC and to determine the first respective pre-MG statuses comprises:
receive a configuration or reconfiguration request; and
in response to receipt of the configuration or reconfiguration request, configure the first respective pre-MG statuses.

57. The apparatus of claim 54, wherein the UE is in NR-DC, wherein to determine the first respective pre-MG statuses comprises:
in response to a BWP switching on the MN, determine the first respective pre-MG statuses from the pre-MG configurations; and
generate, for transmission to the SN, the first respective pre-MG statuses.

58. The apparatus of claim 54, wherein the UE is in NR-DC, wherein to determine the first respective pre-MG statuses comprises:
in response to a BWP switching on the SN, receive, from the SN, third respective pre-MG statuses for the at least one pre-MG as the first respective pre-MG statuses.

59. The apparatus of claim 53, wherein to determine the first respective pre-MG statuses comprises:
generate, for transmission to the UE, one or more pre-MGs of the at least one pre-MG, that are applicable to both the MCG and the SCG; and
in response to a BWP switching on the SN, receive, from the UE, reported pre-MG configurations comprising a set of pre-MG statuses for the one or more pre-MGs, wherein the set of pre-MG statuses is determined by the UE, and wherein corresponding ones of the first respective pre-MG statuses for the one or more pre-MGs are the same as the set of pre-MG statuses.

60. The apparatus of claim 53, wherein to determine the first respective pre-MG statuses comprises:
determine the first respective pre-MG statuses from a network implementation for the MN.

61. One or more non-transitory, computer-readable media having instructions that, when executed, cause processing circuitry:
determine, from pre-configured measurement gap (pre-MG) configurations for at least one pre-MG, first respective pre-MG statuses for the at least one pre-MG, wherein a user equipment (UE) is in dual connectivity (DC) with a master node (MN) and a secondary node (SN),
wherein the MN is associated with a master cell group (MCG) and the SN is associated with a secondary cell group (SCG), and the pre-MG configurations include: first pre-MG flag indications to indicate activation or deactivation statuses for each BWP in the SCG; and second pre-MG flag indications to indicate activation or deactivation statuses for each BWP in the MCG.

62. The one or more non-transitory, computer-readable medium of claim 61, wherein to determine the first respective pre-MG statuses comprises:
for each pre-MG:
determine, from the second pre-MG flag indications, whether at least one of corresponding second pre-MG flag indications for the pre-MG indicates an activation status;
in response to a determination that the at least one of corresponding second pre-MG flag indications indicates an activation status, determine that a pre-MG status for the pre-MG is an activation status; and
in response to a determination that all the corresponding second pre-MG flag indications indicate deactivation statuses, determine that the pre-MG status for the pre-MG is a status indicated by a corresponding one of the first pre-MG flag indications for an active BWP in the MCG.

63. The one or more non-transitory, computer-readable medium of claim 61, wherein the UE is in EN-DC, wherein the second pre-MG flag indications comprise corresponding pre-MG flag indications for each pre-MG that is a per FR2 gap, and wherein to determine the first respective pre-MG statuses comprises:
determine that a pre-MG status for the pre-MG is a status indicated by a corresponding pre-MG flag indication for the pre-MG.

64. The one or more non-transitory, computer-readable medium of claim 61, wherein the UE is in NE-DC, and wherein for each pre-MG that is a per UE gap or a per FR1 gap, to determine the first respective pre-MG statuses comprises:
in response to a BWP switching on the MN, or a configuration or reconfiguration on the MN, receive, from the MN, a corresponding one of second respective pre-MG statuses for the pre-MG as a corresponding first pre-MG status for the pre-MG.

65. The one or more non-transitory, computer-readable medium of claim 61, wherein the UE is in NR-DC, and wherein to determine the first respective pre-MG statuses comprises:
in response to a BWP switching on the MN, or a configuration or reconfiguration on the MN, receive, from the MN, third respective pre-MG statuses for the at least one pre-MG as the first respective pre-MG statuses.
